(19) United States
(12) Patent Application Publication
(10) Pub. No.: US 2010/0239720 A1
(43) Pub. Date: Sep. 23, 2010

(54) DUAL TEXTURED, MULTICOMPONENT SNACK FOOD HAVING A CREAMY FILLING

(76) Inventors: Michael Laurence Jensen, Omaha, NE (US); Jamie Lowell Halgerson, Hopkins, MN (US)

Correspondence Address: Merchant & Gould - ConAgra, P.O. Box 2903, Minneapolis, MN, 55402, US

(21) Appl. No.: 12/729,734

(22) Filed: Mar. 23, 2010

Related U.S. Application Data
(60) Provisional application No. 61/162,494, filed on Mar. 23, 2009.

(51) Int. Cl. A23P 1/12; A21D 13/08

(52) U.S. Cl. 426/94; 426/516

(57) ABSTRACT

A dual textured, multicomponent snack food item comprising an outer jacket and a center filling encased within the outer jacket is disclosed. The center filling has a creamy texture. At the interface between the outer jacket and center filling, the center filling does not substantially migrate into the outer jacket during co-extrusion processing of the food item and/or in the final food item.

This application claims priority to U.S. Patent Application Ser. No. 61/162,494, filed on Mar. 23, 2009, the contents of which are hereby expressly incorporated by reference.

### BACKGROUND

Center-filled food products are available in many varieties and are popular food items. Filled snack products having a crisp baked outer dough shell, and a soft, lubricious creamy filling are preferred by many consumers. The sensory quality of center-filled snack products preferred by such consumers is an interior that is moist or has a creamy texture, the dual texture of the product providing a pleasant eating experience. In order to achieve desirably creamy textures, relatively large amounts of water have been incorporated into some creamy fillings, which have resulted in high water activities. The high water activities associated with these creamy fillings can be problematic, especially when the creamy fillings are used in a product in which it is in contact with materials of considerably lower water content, such as crispy shells.

Due to the disparity in moisture contents of the two materials and the relatively high water activity of the creamy fillings, moisture tends to migrate or weep from the creamy fillings into the shell, making the shell soggy. Creamy fillings having high water activities also provide a medium which is conducive to microbial growth. Thus, ready-to-eat products containing creamy fillings of the prior art tend to have limited shelf lives due to microbial growth.

As a result, some creamy fillings have been formulated with humectants, and the like to yield shelf-stable edible creams that have lower moisture levels or water activity without sacrificing creamy texture. Center-filled snack products made with these creamy fillings generally remain shelf stable for extended periods without becoming soggy or having moisture migrate into the shell if the water activity is reduced to below 0.7. However, low water activity centers are often attained at the sacrifice of product taste and flavor quality.

Creamy fillings have also been formulated to be fat- or oil-based with snack fillings. However, oil separation or fat migration may occur before, during or after processing and/or storage of the snack food product. Oil separation or fat migration is undesirable as it may adversely impact organoleptic properties of the products, such as appearance, mouthfeel and/or taste. For example, oil separation may be considered unsightly to many consumers. In addition, oil separation can lead to drying out of the creamy center to render the center less palatable. Emulsifiers, such as monoglycerides and diglycerides are typically used to stabilize fat-based creamy fillings during processing and/or storage. However, monoglycerides and diglycerides may also undesirably affect the flavor of the creamy filling. For creamy fillings that are prepared from plastic shortenings, fat migration is commonly observed due in part to incomplete re-crystallization during or after co-extrusion. Incomplete recrystallization occurs because the plastic shortening is not able to harden or set up in the time period (1) required to fill the interior of the product or (2) before exiting the extruder. Furthermore, plastic shortenings are very high in trans fat which has been linked to increase cardiovascular risk. To circumvent fat migration and oil evaporation, food pastes that are high in viscosity or jam-like are often used as a substitute. However, the food pastes do not provide the consistency, mouth feel and thermoplastic nature of a semi-solid creamy filling that appeals to consumers.

Furthermore, use of fat- or oil-based filings pose additional problems due the type of fat used. For example, conventional shortenings are typically hydrogenated to enable processing via co-extrusion as is commonly used when producing dual textured or filled snack products. Hydrogenation introduces significant quantifies of trans fatty acids which have been linked to numerous risk factors, such as cardiovascular risk. Current creamy fillings are formulated with partially hydrogenated fats and therefore contain high levels of trans fatty acids. Hence, developing a crunchy snack food product with a creamy filling that delivers the desirable sensory experience, is capable of withstanding processing conditions, has minimal amounts of trans fatty acids and does not undergo water and/or oil migration during or after processing and/or storage would be desirable.

### BRIEF DESCRIPTION OF THE DRAWINGS

FIG. 1 is a flow diagram illustrating a process for preparing a dual textured multicomponent snack food comprising an outer jacket and center filling.

### SUMMARY OF THE INVENTION

Dual textured, multicomponent co-extruded snack food items that include an outer jacket and a center filling encased within the outer jacket are disclosed. The outer jacket comprises about 60% to about 80% by weight of the food item. The outer jacket generally comprises at least about 40% to about 92% by weight of a starch-containing material. The outer jacket can be crispy or crunchy.

The center filling comprises about 30% to about 50% by weight of the food item encased within the outer jacket. The center filling can have a creamy texture. The center filling is capable of withstanding processing conditions and does not undergo substantial water and/or oil migration during or after processing and/or storage. In one example, the center filling comprises about 40% to about 95% by weight of a fat composition, about 5% to about 60% by weight of a flavoring component, and about 0% to about 2% be weight of an emulsifier. In another example, the center filling comprises about 10% to about 95% by weight of a fat composition, about 10% to about 50% by weight of a foam composition, about 5% to about 60% by weight of a flavoring component, and about 0% to about 2% be weight of an emulsifier.

The foam composition can be marshmallow crème or marshmallow fluff. In an example, the marshmallow crème comprises about 45% to about 65% low D.E. corn syrup by weight, about 15% to about 30% sugar by weight, about 10% to about 20% egg white by weight, about 2% or less cream of tartar by weight; about 2% or less xanthan gum by weight; and about 2% or less artificial flavor by weight.

### DETAILED DESCRIPTION

### I. Definitions

“Saturated fat” as used herein includes fat that consists of triglycerides containing only saturated fatty acids or fatty acids with single covalent bonds between the carbons of its fatty acids. The term “saturated fat” also includes a fat whose available bonding sites are entirely filled with hydrogen atoms or a lipid that contains no carbon-carbon double bonds. The term “saturated fat” also encompasses a fat or oil that is usually solid at a room temperature of about 70° F.

The term “trans fat” is the common name for a type of unsaturated fat with one or more trans-isomer fatty acids. As used herein, the term “trans fat” includes the terms “trans fatty acids” and “trans fats”. The term “trans fatty acids”, as used herein, includes an unsaturated fat having carbon-carbon double bonds in the trans configuration.

As used herein, the term “starch-based material” means high polymeric carbohydrates composed of glucopyranose units, in either natural, dehydrated (e.g., flakes, granules, meal) or flour form.

As used herein, the term “monounsaturated fat” means fat with one carbon-carbon double bond or a fat comprising fatty acids that have a single double bond in the fatty acid chain. The term “monounsaturated fat” specifies all of the remainder of the carbon atoms in the chain are single-bonded. In general, monounsaturated fats are liquid at a room temperature of about 70° F.

As used herein, the term “polyunsaturated fat” refers to a fat containing two or more carbon-carbon double bonds or a class of fats having long-carbon chains with many double bonds unsaturated with hydrogen atoms. The term “polyunsaturated fat” is also meant to refer to a fat that has more than one double bond in the molecule. Polyunsaturated fats are generally liquid at a room temperature of about 70° F.

As used herein, the term “unsaturated fat” refers to a fat comprising at least one fatty acid in which there are one or more double bonds in the fatty acid chain.

As used herein, the term “paste” refers to mixture having of a soft and malleable consistency. In addition, the term “paste” refers to a substance that behaves as a solid until a sufficiently large load or stress or force is applied, at which point the substance flows like a fluid.

As used herein, the term “creamy texture” refers to a material that is soft, smooth, spreadable, thermoplastic and/or flowable in consistency, mouthfeel, body, and viscosity. In addition, the term “creamy texture, as used herein, refers to a material having a cream-like matrix or thick texture of cream or milk fat.

As used herein, the term “creamy taste” or “creamy flavor” refers to the taste sensation of smooth, rich, fatty, buttery, and/or vanilla taste of a material.

As used herein the term “creamy texture” is not used interchangeably with the term “creamy flavor or taste” unless specified otherwise. Creamy texture refers to the thermo-mechanical properties of a material, such as the consistency and/or body, while a creamy flavor profile refers to the flavor and/or aroma compounds that are present in the material.

As used herein, the term “center filling” is used interchangeably with the term “center filling component”.

As used herein, the term “outer jacket” is used interchangeably with the term “outer jacket component”.

As used herein, the term “water activity” is defined as the vapor pressure of water above a sample divided by that of pure water at the same temperature where pure distilled water has a water activity of exactly one. In addition, the term “water activity” refers to the ratio between the vapor pressure of water in a food and that of pure water at the same temperature.

“High melting point fraction” means the fraction of an oil, fat, or lipid material melts at a temperature of about 100° F. or more or is solid at a temperature of about 100° F. or less. “Low melting point fraction” means the fraction of an oil, fat, or lipid material melts at a temperature of about 35° F. or more or is solid at a temperature of about 35° F. or less.

As used herein, the term “fat” refers to generally triesters of glycerol and fatty acids. Fats may be either solid or liquid at a normal room temperature of about 70° F., depending on their structure and composition. Although the words “oils”, “fats”, and “lipids” are all used to refer to fats, “oils” is usually used to refer to fats that are liquids at a room temperature of about 70° F., while “fats” is usually used to refer to fats that are solids at a room temperature of about 70° F. “Lipids” is used to refer to both liquid and solid fats, along with other related substances. The terms “oil” and “fat” as used herein may be considered interchangeable. Furthermore, while a fat usually refers to oil in a substantially solid form, at a particular temperature such a solid fat will become oil when heated to a particular temperature. In the same way substantially all oils will solidify when cooled to a low enough temperature. Therefore, in the context of this specification the terms will be used in a manner to reflect the prevalent state of the material being described. Unless the context dictates a contrary conclusion; however, reference to the prevalent state should not be construed as a limitation because a change in temperature or substitution of oil for a fat or a fat for an oil is always possible.

As used herein the term “emulsifier” refers to a surface-active agent that promotes the formation of an emulsion.

As used herein the term “stabilizer” refers to an agent that is added to a solution, mixture, suspension or composition in order to maintain the solution, mixture, suspension or composition in a stable or unchanging state or reduces or inhibits phase separation in the solution, mixture, suspension or composition.

As used herein, the term “phase separation” refers to the separation of a relatively uniform and homogeneous composition into two or more distinct and mechanically separable portions or layers.

As used herein, the term “thermoplastic” refers to a material that softens or becomes more fluid and less viscous when heated and hardens or becomes more viscous again when cooled.

As used herein, the term “texturizer” refers to any farinaceous food product that does not completely gelatinize into a homogenous material when heated. Furthermore, the term “texturizer” refers to a farinaceous food product that does not completely dissolve in water to thereby contribute to the texture of the extruded product.

### II. Modes for Carrying Out the Invention

Dual textured foods have different textures and liquid levels which can give rise to liquid migration. The poor stability of creamy fillings used to prepare certain snack foods results in wicking of the filling or moisture or lipid from the filling into the outer jacket of the snack food during or after processing and/or storage.

A dual textured, mulitcomponent snack food product with a creamy filling that delivers a desirable sensory experience, is capable of withstanding processing conditions, has minimal amounts of trans fatty acids and does not undergo water and/or oil migration during or after processing and/or storage is disclosed. It has been surprisingly found that the center fillings of the disclosure can be extruded or used to fill and prepare snack foods that do not undergo liquid migration, fat migration, or oil separation during or after processing. The center fillings of the disclosure typically have a creamy texture, and have been found to generally harden, set up and/or recrystallize at the time and temperature conditions used during co-extrusion before the fat can substantially leak or wick out into the outer jacket of the snack food jacket. As the center fillings of the present invention are fat-based, the fillings are less susceptible to microbial attack than water based fillings as the water activity of the center fillings of the disclosure are lower than the water activity of the conventional water based fillings. Furthermore, the center fillings are low in trans fat, having about 5% or less trans fat by weight.

### A. Compositions

The dual-textured snack foods of the disclosure are a multi-component food product having an outer jacket component substantially surrounding, enclosing, or encasing an inner center filling component. In an example, the outer jacket component forms a shell encasing the center filling component. The outer jacket can be crispy, crunchy, and/or flakey. Preferably the center filling has a creamy texture.

In general, the composition of the outer jacket and center filling are selected such that the center filing is in contact with an inner surface of the outer jacket but not substantially blended into the outer jacket. At the interface between the outer jacket and center filling, the center filing component preferably does not substantially migrate or wick into the outer jacket component during processing and/or in the final multi-component food product. In one example, less than about 10%, less than about 5%, less than about 4%, less than about 3%, less than about 2%, less than about 1% by weight of the center filling migrates into the outer jacket. In another example, the center filling migrates into less than about 10%, less than about 5%, less than about 4%, less than about 3%, less than about 2% or less than about 1% of the volume of the outer jacket. In another example, the center filling is migrated less than about 5 millimeters into the outer jacket.

The center filling comprises a fat composition, a flavor component, and an emulsifier component that forms a soft cream-like matrix. The center filling can comprise about 10 to about 95% by weight fat and about 5% to about 60% by weight of the flavor component. The center filling can also include a foam component. Several exemplary formulations for the center filling are shown in Table 1.

TABLE 1

| | Formula 1 | Formula 2 |
|---|---|---|
| INGREDIENT | [% by WGT] | [% by WGT] |
| Fat composition | 10 to 95 | 40 to 95 |
| Foam component | 10 to 50 | — |
| Flavor component | 5 to 60 | 5 to 60 |
| Emulsifier component | 0 to 2 | 0 to 2 |

The fat composition can be up to about 95% by weight of the center filling. In one example, the fat composition of the center filling component is about 40% to about 50% by weight, about 45% to about 55% by weight, about 50% to about 60% by weight, about 55% to about 65% by weight, about 60% to about 70% by weight, about 65% to about 75%, about 70% to about 80% by weight, about 75% to about 85% by weight, about 80% to about 90% by weight, or about 85% to about 95% by weight. In another example, the fat composition comprises about 95%, about 90%, about 85%, about 80%, about 75%, about 70%, about 65%, about 60%, about 55%, about 50%, about 45%, or about 40% by weight of the center filing component.

The fat composition can include a mixture of liquid and solid fats. Preferably, the liquid fat is entrapped or fixed within a crystalline structure of the solid fat to inhibit, minimize, and/or prevent wicking of the liquid fat into the outer jacket component. In an example, the fat composition is a plastic shortening that does not substantially migrate or wick into the outer jacket component during processing and/or in the final food product.

An exemplary fat composition formula is shown in Table 2.

TABLE 2

| INGREDIENT | % by WGT |
|---|---|
| Fat component | 98 to 100 |
| Emulsifier component | 0 to 2 |

The fat component can include one or more fat components. The fat component can comprise up to about 100% by weight of the fat composition. In an example, the fat component comprises about 98% to about 99.5% by weight of the fat composition. In an example, the fat component comprises about 99.5%, about 99%, about 98.5%, about 98%, about 97.5%, about 97%, about 96.5%, about 96%, about 95.5%, about 95%, about 94.5%, about 94%, about 93.5%, about 93%, about 92.5%, about 92%, about 91.5%, about 91%, about 90.5%, or about 90% weight of the fat composition. In an example, the fat composition comprises about 98% to about 99.5% by weight fat component and about 0% to about 2% by weight emulsifier component.

The fat component can include any fat, oil, or mixture thereof that is suitable for human or animal consumption. The fat component can include unsaturated fats, monounsaturated fats, polyunsaturated fats, or any combination thereof. In addition, the fat component can include any saturated fat in combination with any monounsaturated or polyunsaturated fat. In one example, the fat component comprises a polyunsaturated fat and a monounsaturated fat. In another example, the fat component comprises about 40 grams of polyunsaturated fats and about 21 grams of monounsaturated fats. In another example, the fat component comprises about 9 grams of polyunsaturated fats and about 37 grams of monounsaturated fats.

Examples of suitable fats and oils include, but are not limited to, any vegetable oils or fats, such as soybean oil, rapeseed oil, corn oil, sunflower oil, palm oil, canola oil, modified canola oil, high stability canola oil, high stability soybean oil, safflower oil, coconut oil, cottonseed oil, peanut oil, palm oil, butterfat, cocoa butter, cocoa butter substitutes, canola oil, hazelnut oil, rice bran oil, olive oil, vegetable oils, frying fats, margarines, shortenings, bakery fats, cream filling fats, choco spreads, powdered fats, animal feeds, or any combination thereof. These fats are well known in the art and often include antioxidants, preservatives, acidulants, and the like. Examples of commercially available fats include Bunge NH 50 Palm Shortening, Bunge Elite Vream Right All Purpose Shortening (Bunge Corporation, St. Louis, Mo.) and Soy-HS Canola oil (Bunge Corporation, St. Louis, Mo.).

The fat can be any fully or partially hydrogenated fat, structuring fat, such as a hardstock fat, fully hardened edible oil or a hardened fat. The fat component can include 1,3-dipalmitoyl-2-monooleine (POP), 1(3)-palmitoyl-3(1)-stearoyl-2-monooleine (POSt), 1,3-distearoyl-2-monooleine (StOSt), behenic acid triglyceride, trioleine, tripalmitine, tristearine, triglycerides of medium chain fatty acids, or combinations thereof, or fractionated oils like palm olein, palm kernel olein, palm kernel stearine, and/or palm stearine. In an example, the fat component has a melting point of about 100° F. or greater.

Preferably, the trans fat level of the fat composition comprises less than about 10%, less than about 9%, less than about 8%, less than about 7%, less than about 6%, less than about 5%, less than about 4.5%, less than about 4%, less than about 3.5%, less than about 3%, less than about 2.5%, less than about 2%, less than about 1.5%, less than about 1%, less than about 0.5%, less than about 0.1%, or 0% by weight.

In one example, the fat composition comprises a partially hydrogenated fat that is at least semi-solid at a room temperature of about 70° F. In another example, the fat composition comprises a partially hydrogenated fat that is semi-solid at a room temperature of about 70° F. and comprises a trans fatty acid content of less than about 5% by weight of the fat composition. In another example, the fat composition comprises a partially hydrogenated fat that comprises a solid fat index of about 47-55 at about 10° C., about 20-25 at about 21.1° C., about 11-15 at about 26.7° C., about 5.5-7.5 at about 33.3° C., and about 1-3.5 at about 40° C. In another example, the fat composition comprises a partially hydrogenated fat that comprises a solid fat index of less than about 23 at about 10° C., of less than about 19 at about 21.1° C., of less than about 15.5 at about 26.7° C., of less than about 14 at about 33.3° C., and of less than about 11 at about 40° C.

The fat composition can include saturated fats. In one example, the fat composition comprises about 50% or less, about 45% or less, about 40% or less, about 35% or less, about 30% or less, about 25% or less, about 20% or less, about 15% or less, or about 10% or less saturated fat by weight.

The center filling can include one or more flavor components. The flavor components can be dry or liquid. The flavor component can have a concentration of up to about 60% by weight of the center filling components. In one example, the flavor component comprises about 60%, about 55%, about 50%, about 45%, about 40%, about 35%, about 30%, about 25%, about 20%, about 15%, about 10%, or about 5% by weight of the center filling component. In another example, the flavoring component comprises about 5% to about 60%, about 10% to about 60%, about 20% to about 60%, about 30% to about 60%, about 30% to about 50%, about 30% to about 40%, about 40% to about 50% by weight of the center filling component. In an example, the center filling comprises about 25% to about 40% by weight flavor components and about 60% to about 75% by weight of the fat composition. In an example, the center filling comprises about 25% by weight flavor components and about 75% by weight of the fat composition. In an example, the center filling comprises about 40% by weight flavor components and about 60% by weight of the fat composition. In an example, the center filling comprises about 30% by weight flavor components and about 70% by weight of the fat composition.

The flavor component can be supplied as individual flavors or various prepared mixtures of two or more flavors. Examples of commercially available flavors include but are not limited to, natural fruit flavor, artificial or natural vegetable flavor, artificial or natural meat flavor, chocolate, vanilla, cinnamon, sugar, BBQ, peppercorn, sour cream, MSG, ranch, salt seasoning, pepper, cumin coriander, grape, apple, orange, peach, banana, strawberry, raspberry, per, mango, papaya, pomegranate, blueberry, cherry, pumpkin, peas, carrot, corn, sweet potato, tomato, onion, garlic pepper, squash, jalapeno, sweet flavors, cool flavors, hot flavors, or savory flavors. Examples of commercially available flavors include, but are not limited to, IFF cheddar flavor SN892074, Kraft cheddar flavor SEQUOIA, Cargill cheddar flavor 505-00166, Cargill® cheddar flavor 505-00165, Kraft Cheddar Sharpe QB cheese, Kerry cheddar Chez Tone 113, IFF cheddar flavor SN894245, Givaudan cheddar flavor LR-758-625-9, and ConAgra Foods® Peter Pan Peanut Butter.

The fat composition can include an emulsifier component. The emulsifier component can be pre-blended with both the fat component(s) or separately added to form the fat composition. The emulsifier component provides an additional high melting point fraction to the fat composition to enable the fat composition to recrystallize at a faster rate during co-extrusion. In one example, the emulsifier component enables recrystallization of the center filling component to occur in less than about 30 seconds. In another example, the emulsifier component enables recrystallization or the center filling component to occur in less than about 15 seconds.

The emulsifier component typically includes one or more emulsifiers. Suitable examples of emulsifiers include but are not limited to lecithin, monoglycerides, diglycerides, whey protein concentrates, casein, modified lecithin, distilled monoglycerides, distilled diglycerides, polyethylene glycol, propylene glycol, and combinations thereof.

Examples of commercially available emulsifiers include, but are not limited to DIMODAN HS K-A™ distilled monoglyceride (Gristed Ingredients, Inc., New Century, Kans.), MONICS™ (Food Basics of Holland), ADG™ distilled monoglycerides (Archer Daniels Midland Company, Decatur, Ill.), de-oiled soybean lecithin, such as NUTRIPUR™ de-oiled, powdered, soybean lecithin (Lucas Meyer Inc., Decatur, Ill.), and MAXEMUL™ 210 blend of refined fluid soy lecithin, propylene glycol, ethoxylated monoglycerides and ethoxylated diglycerides (Central Soya Corp., Fort Wayne, Ind.).

The emulsifier component comprises up to about 2% by weight of the fat composition. In one example, the emulsifier component comprises about 2%, about 1.75%, about 1.5%, about 1.25%, about 1.00, about 0.75%, about 0.50%, or about 0.25% by weight of the fat composition. In another example, the emulsifier component comprises about 0.75% by weight of the fat composition. In another example, the emulsifier component comprises about 0.5% to about 2.0%, about 0.75% to about 1.75%, or about 1.00% to about 1.50% by weight of the fat composition.

The center filling component can include a foam component. Examples of a foam component include but are not limited to marshmallow crème and marshmallow fluff. The foam component generally comprises a bulking agent, a sweetening agent, a protein component, a whipping agent, a stabilizing agent, and optional additives. In an example, the foam component comprises as a whipped confectionary syrup having a semi-fluid consistency at a room temperature of about 70° F.

The foam component can comprise up to about 50% by weight of the inner component. In one example, the foam component comprises about 50%, about 45%, about 40%, about 35%, about 30%, about 25%, about 20%, about 15%, or about 10% by weight of the center filling. In another example, the foam component comprises about 10% to about 50%, about 20% to about 50%, about 30% to about 50%, about 40% to about 50%, or about 30% to about 40% by weight of the center filling.

The bulking agent can provide cohesiveness and structural integrity to the foam component. The bulking agent can comprise about 45 to about 65% by weight of the foam component. In one example, the bulking agent comprises about 65%, about 60%, about 55%, about 50%, or about 45% by weight of the foam component. Suitable examples of bulking agents include, but are not limited to corn syrup solids, liquid corn sweetener, starches, lactose, dextrose, maltose, or maltodextrins.

The sweetening agent can comprise 15% to 30% by weight of the component. In one example, the sweetening agent comprises about 30%, about 25%, about 20%, or about 15% by weight of the foam component. Examples of sweetening agents include, for example, sucrose (sugar), fructose, corn syrup, honey, molasses, malt syrups, individually or in any combinations thereof. The sweetening agent concentration and sweetener type can be altered to suit the desired end-product. The sweetening agent can be nutritive, non-nutritive, or a combination thereof. In general, the sweetening agents may broadly range from those of a higher sweetening power (e.g., non-nutritive sweeteners such as saccharin, cyclamates, dipeptides, chalcones, etc.) to those of weak sweeteners (e.g., low D.E. starch hydrolyzates). Either crystallizable or non-cystallizable sweetening agents may be freely interchanged, as desired, in the foam component. The foam composition can also include a sweetness masking agent. One example of a suitable sweetness masking agent is Super Envision® flavor and texture modifier (Domino Specialty Ingredients, Baltimore, Md.). In an example, the foam composition of the disclosure comprises about 2% to about 8% by weight sweetness masking agent.

In an example, the sweetening agent comprises corn syrup. Corn syrups can be classified on the basis of D.E. values. The term “D.E.” is used herein to refer to the reducing sugars content of the dissolved solids in starch hydrolysates, expressed as percent dextrose, as measured by the Luff-Schoorl method (NBS circular C-40, page 195 as appearing in “Polarimetry, Saccharimetry and the Reducing Sugars” by Frederick J. Bates and Associates). Preferably the corn syrup is a low D.E. corn syrup. In an example, the corn syrup comprises a D.E. of less than about 35, of less than about 30, of less than about 25, of less than about 20, of less than about 15, of less than about 10, or of less than about 5. In another example, the corn syrup comprises a D.E. of about 5 to about 30, about 5 to about 20, about 5 to about 15, about 10 to about 30, about 10 to about 20, about 10 to about 15, or about 5 to about 25.

The protein component is typically water-soluble over a broad temperature range and pH range. In an example the protein component is water soluble at temperatures of about 25° C. to about 180° C., and pH range of about 4-8. In an example, the protein component is an undenatured, water-soluble, film-forming, protein that works with the bulking agent to provide a three-dimensional matrix that uniformly entraps and maintains gas in the form of minute gas bubbles within the foam component at a wide range of temperatures.

Suitable examples of proteins that can be used as a protein agent, include, but not limited to, liquid egg whites, dry egg whites, milk powder, dry milk powder, soy protein hydrolyzates, egg albumen, sodium caseinate, malted milk, soy protein, soy protein concentrate, soy protein isolate, and mixtures thereof. The protein component can comprise about 10 to about 20% by weight of the foam component. In one example, the protein component comprises about 20%, about 15%, or about 10% by weight of the foam component.

The whipping agent can facilitate the incorporation of air and/or gas into the foam component. Suitable examples of the whipping agent include cream of tartar. In an example, the whipping agent comprises less than about 2% by weight of the foam component.

The stabilizer agent comprises less than about 2% by weight of the foam component. The stabilizer agent be supplied as individual stabilizers or in various prepared mixtures of two or more stabilizers that are blended to form the stabilizing component. Suitable examples of stabilizers include, but are not limited to, xanthan gum, locust bean gum, guar gum, konjac, iota carrageenan, kappa carrageenan, lambda carrageenan, carboxymethylcellulose, pectin, tamarind, gellan gum, agar, gelatin, alginate, or a mixture thereof.

Optional additives can be included as part of the foam component at levels of up to about 5% by weight of the foam component. Suitable examples include, but are not limited to, flavoring, coloring agents, microbides, antioxidants, acidulants, humectants, fats, oils, surface active agents, gums, starches, solid or particulated foods (e.g., nuts, etc.). The optional additive(s) may be incorporated into the foam component, provided it does not destroy the aerating characteristics of the whipping agent. In general, the foam component is infused with a sufficient amount of gas to provide a finished confection having a specific gravity of less than 0.75 (i.e., less 0.75 gms/ml.).

The foam component can be a marshmallow crème or fluff. In an example, the marshmallow crème comprises about 45% to about 65% by weight liquid, low D.E. corn syrup, about 15% to about 30% by weight sugar, about 10% to about 20% by weight egg weight, 2% or less by weight cream of tartar, 2% or less by weight xantham gram, and 2% or less by weight artificial color. Preferably the low D.E. corn syrup comprises 35 D.E. or less. In an example, the corn syrup comprises about 5 D.E. to about 25 D.E.

When the center filling comprises a foam component, the fat composition comprises up to about 95% by weight of the center filling component. In one example, the fat composition comprises about 95%, about 90%, about 85%, about 80%, about 75%, about 70%, about 65%, about 60%, about 55%, about 50%, about 45%, about 40%, about 35%, about 30%, about 25%, about 20%, about 15%, or about 10% by weight of the center filling component. In another example, the fat composition comprises about 10 to about 95% by weight, about 20% to about 75% by weight, or about 40% to about 55% by weight of a center filling component that includes a foam component. In another example, the fat composition comprises about 40% to about 50% by weight, about 45% to about 55% by weight, about 50% to about 60% by weight, about 50% to about 90%, about 55% to about 65% by weight, about 60% to about 70% by weight, about 65% to about 75%, about 70% to about 80% by weight, about 75% to about 85% by weight, about 80% to about 90% by weight, or about 85% to about 95% by weight of a center filling component includes a foam component.

For center fillings comprising a foam component, the flavoring component comprises from about 5% to about 60% by weight of the center filling. In one example, the flavoring component comprises about 60%, about 55%, about 50%, about 45%, about 40%, about 35%, about 30%, about 25%, about 20%, about 15%, about 10%, or about 5% by weight of the center filling. In another example, the flavoring component comprises about 40% by weight of the center filling.

The center filling component comprises as much as 50% by weight of the snack food. In an example, the center filing component comprises about 50% to about 20%, about 50% to about 30%, about 50% to about 40%, about 45% to about 35%, about 40% to about 30%, about 40% to about 20%, about 35% to about 30%, about 30% to about 20% or about 25% to about 20% by weight of the snack food. In another example, the center filling component comprises from about 10% to about 40% by weight of the snack food. In another example, the center filling component comprises from about 10% to about 30% by weight of the snack food. In another example, the center filling comprises about 40% by weight of the snack food.

As the soft cream-like matrix of the center filling component is formed without needing any added water, the center filling comprises minimal water content and very low water activity levels. Consequently, the center filling component does not generally require rigorous sterilization techniques or antimicrobial/antimycotic agents for stabilization. In addition, the center filling component does not typically require any moisture control ingredients.

In an example, the center filling component comprises less than 10% moisture by weight. In another example, the center filling component comprises less than about 9%, less than about 8%, less than about 7%, less than about 6%, or less than about 5% moisture by weight. In another example, the center filling component comprises about 3% to about 7% moisture by weight. In yet another example, the center filling component comprises about 3% to about 5% moisture by weight.

In an example, the center filling component comprises a water activity (a_{w}) of less than 0.7. In another example, the center filling component comprises a water activity of about 0.3 to about 0.6. In another example, the center filling component comprises a water activity of about 0.5 to about 0.6. In yet another example, the center filling component comprises a water activity of about 0.3 to about 0.4.

The outer jacket component is starch-based and is preferably harder than the center filling component. In an example, the outer jacket component has a crispy, flakey, or crunchy texture. In an example, the outer jacket comprises a cracker, cereal, or biscuit. The outer component can have an aligned “fibrous” texture created via extrusion process.

The outer jacket component comprises as much as 80% by weight of the snack food. In an example, the center filing component comprises about 80% to about 50%, about 80% to about 60%, about 80% to about 70%, about 70% to about 60%, about 70% to about 50%, or about 60% to about 50% by weight of the snack food. In another example, outer jacket component comprises about 80%, about 75%, about 70%, about 65%, about 60%, about 55%, or about 50% by weight of the snack food.

The outer jacket component comprises at least one starch-containing component. An exemplary formulation for the out jacket composition is shown in Table 3.

TABLE 3

| INGREDIENT | % by WGT |
|---|---|
| Starch-based material | 40 to 92 |
| Texturizing agent | 0 to 15 |
| Optional additives | 0 to 7 |

The starch-containing component can be supplied as individual starch-containing materials or various prepared mixtures of starch-containing materials. The starch materials may be any comminuted cereal grain or edible seed meal, derivatives thereof and mixtures thereof. Suitable examples of starch-containing components include, but are not limited to whole corn flour, all purpose white wheat flour, whole wheat flour, corn flour, oat flour, barley flour, rye flour, rice flour, potato flour, grain sorghum flour, potato flakes, oat meal, wheat semolina, rice flour, rice meal, corn cones, corn starch, physically and/or chemically modified flours or starches, such as pregelatinized starches. The starch-based materials include, but are not limited to, potato flour, potato granules, corn flour, masa corn flour, tapioca, buckwheat flour, bean flour, barley flour, as well as modified starches, native starches, dehydrated starches, starches derived from tubers, legumes and grain, for example cornstarch, wheat starch, rice starch, waxy corn starch, oat starch, cassaya starch, waxy barley, waxy rice starch, glutinous rice starch, sweet rice starch, amioca, potato starch, and mixtures thereof. The flours may be bleached or unbleached.

The starch-containing component comprises about 40% to about 92% by weight of the jacket composition. In one example, the starch-containing component comprises less than about 92%, less than about 90%, less than about 85%, less than about 80%, less than about 79%, or less than about 78% by weight of the shell composition. In another example, the starch-containing component comprises about 92% by weight of the jacket composition.

The outer jacket component can include one or more texturizing agents. The texturizing agent can be supplied as individual texturizers or various prepared mixtures of two or more texturizers. Examples of suitable texturizers include, but are not limited to, vegetable power, corn meal, corn grist, corn flaking grits, wheat fibers, baking powder, seed meal, double action baking powder, potato granules, grain bran, fiber, gums, hydrocolloids, and the like. The texturizing agent comprises up to about 15% by weight of the jacket composition. In one example, the texturizing agent comprises less than about 3%, less than about 2.9%, less than about 2.8%, less than about 2.7%, less than about 2.6%, less than about 2.5%, or less than about 2.0% by weight of the jacket composition.

The outer jacket component can also include optional additives, such as flavors and sweetening agents. The optional additives can comprise up to about 7% by weight of the jacket composition. In one example, the optional additives comprise less than about 7%, less than about 6.5%, less than about 6%, less than about 5.5% or less than about 5% by weight of the jacket composition. In another example, the optional additives comprise about 6.2% by weight of the jacket composition.

The dried textured multicomponent snack foods of the invention is generally sized and configured for human consumption without requiring eating implements. Typically the size of the snack food item are bite-sized or smaller, for example, about 0.25 cm to about 10 cm, or alternatively about 0.5 cm to about 3 cm. Bite-sized pieces are frequently about 2 cm to about 3 cm, and for example about 2.5 cm. Smaller sized pieces comprise a size of about 0.5 cm to about 2 cm, or about 0.5 cm to about 1 cm. Individual snack foods typically weight about 0.25 grams to about 10 grams. Furthermore, the snack food is generally shaped for human consumption, such as cubes, bars, gloves, ovoids, pyramidal shapes, pillows, squares, hexagons, chevrons, waves, novelty shapes such as cartoon characters and the like.

### B. Methods of Making

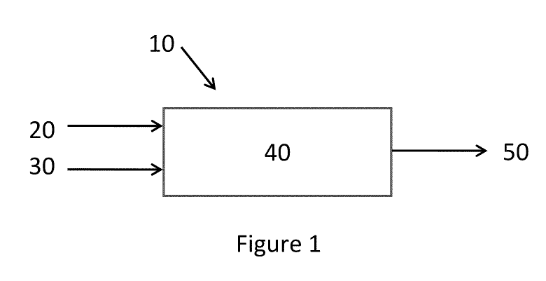

A method of preparing dual textured multicomponent snack foods with an outer jacket and center filling is generally illustrated at 10 in FIG. 1. In the process 10, a center filling 20 in the form of homogenous viscous slurry and a jacket composition 30 in the form of an extrudable dough are introduced into a co-extruder 40. The co-extruder 40 co-extrudes the center filling 20 and the jacket composition 30 to form a dual-textured snack food 50 of the disclosure.

The center filing 20 can be prepared by heating a mixture that includes the fat component(s) and emulsifier component(s) to a temperature of more than about 120° F. to form a liquefied fat composition. Solid fat components and any solid fat components of the optional additive(s) are melted in a mixer. Preferably, the fat crystalline structures and fat crystal nuclei of the fat components and the emulsifier components are liquefied and lose crystalline memory to minimize, and preferably eliminate, premature fat crystal formation in the liquid fat composition before fat crystal formation is desired. Next, the flavor component is mixed with the liquid fat composition to form a fluid or semi-fluid center filling component that is pumpable by a co-extruder.

In a separate step, the outer jacket component 30 can be formed by blending the dry ingredients in a mixer. The dry mix is fed to the co-extruder where any liquid ingredients are added to form an extrudable dough. The extrudable dough is introduced into a co-extruder operating at a temperature range of about 350° F. to about 392° F. Screw flights present in the co-extruder generate mechanical heat and shear within the dough to form an extrudate that is transported along the length of a barrel of the co-extruder. As processing nears completion, the extrudate enters the co-extrusion die which concurrently forms and fills the product. Upon exiting from the extruder, the extrudate expands and cools to form the outer jacket.

The snack food 50 product can be shaped and cut by a cutting device located downstream from the co-extruder to form a shaped dual-textured snack food (not shown). Thereafter, the dual textured snack food 50 may enter a belt dryer to reduce the moisture content of the snack food 50. Alternatively, the snack food 50 can be transported to an oven for additional baking to form the desired texture of the snack food 50. In a third alternative, the snack food 50 may be enrobed in a sweet or savory coating upon exiting the co-extruder.

In another method and apparatus for manufacturing the dual-textured snack food, the center filling component and the outer jacket component, which is in the form of a dough-type material is continuously co-extruded. The two components are continuously coextruded and then cut into individual pieces to produce the dual-textured snack food product. Another method of preparing the dual textured snack food product of the present invention involves using the center filling component to continuously center-fill an extruded collet or C-shell. Suitable examples of processes and equipment for center-filling an extruded collet or C-shell are known in the art. See, for example, U.S. Pat. No. 3,615,675.

In another example, a puffed, expanded food product filled with the center filling of the invention can be produced by extruding a farinaceous outer jacket material, such as the starch-containing outer jacket component described herein, through a generally C-shaped or annular die at a temperature which causes the water in the mixture to vaporize upon exiting the extruder, thereby puffing the extrudate. A tube extending through the center of the die orifice allows the center filling of the invention to be continuously pumped into the central cavity of the extrudate as it emerges from the die. The filled material is then passed through an oven to reduce the moisture content of the outer shell, thereby rendering it crispy. The rapid recrystallization characteristic of the center filling of the invention allows the center filling to set up into a soft thermoplastic filing that does not leak, the filling retains its moist, creamy character through the baking process, so that the final product has duality of texture, i.e., a crisp outer shell material combined with a soft, center filling having a creamy texture.

Due to the low water activities of the center filling component, the dual-textured snack food is shelf-stable and the low water activity inhibits microbial growth. In addition, since the fillings are oil-based, the filled snack foods resist oil migration from the filling into the shell of the product. Consequently, the filled dual textured snack foods incorporating the center filings of the invention have shelf lives of about 60-90 days under standard storage conditions.

### EXAMPLES

The present invention may be better understood with reference to the following examples. These examples are intended to be representative of specific embodiments of the invention and are not intended as limiting the scope of the invention.

### Example 1

Dual-textured snack foods comprising crunchy outer shells and center fillings having a creamy texture were prepared. Exemplary formulations are shown in Table 4. The concentration units disclosed in Table 4 are percent (%) by weight dairy base unless specified otherwise.

For formulas 1-3, the fat component, emulsifier component and any vegetable oil were heated to a temperature of more than 120° F. in a mixer to form a liquid fat composition. Next, the dry flavors were added along with the foam component to form the filling composition.

In a separate step, all the ingredients of the jacket composition were blended with water blended to form a dough. The dough was cut into pillows and baked at a temperature of about 350° F. After baking, the filling composition was injected into the pillows at a ratio of 60:40 (jacket to filling) to form dual-textured snack foods.

TABLE 4

| INGREDIENTS | #1 | #2 | #3 |
|---|---|---|---|
| Fat component | 98.25 | 98.00 | 99.50 |
| Emulsifier component | 0.75 | 2.00 | 0.50 |
| Vegetable oil | 1.00 | 0.00 | 0.00 |
| Fat composition | 100.00 | 100.00 | 100.00 |
| Dry flavoring | 40.00 | 40.00 | 40.00 |
| Fat composition | 60.00 | 30.00 | 20.00 |
| Marshmallow crème | 0.00 | 30.00 | 40.00 |
| Filling composition | 100.00 | 100.00 | 100.00 |
| Flour | 79.08 | 79.08 | 79.08 |
| Sugar | 5.00 | 5.00 | 5.00 |
| Baking powder | 0.80 | 0.80 | 0.80 |
| Salt | 1.12 | 1.12 | 1.12 |
| Texturing agent | 14 | 14 | 14 |
| Jacket Composition | 100.00 | 100.00 | 100.00 |

It should be noted that, as used in this specification and the appended claims, the singular forms “a,” “an,” and “the” include plural referents unless the content clearly dictates otherwise. Thus, for example, reference to a composition containing “a compound” includes a mixture of two or more compounds. It should also be noted that the term “or” is generally employed in its sense including “and/or” unless the content clearly dictates otherwise.

All publications and patent applications in this specification are indicative of the level of ordinary skill in the art to which this invention pertains. All publications and patent applications are herein incorporated by reference to the same extent as if each individual publication or patent application was specifically and individually indicated by reference.

The invention has been described with reference to various specific and preferred embodiments and techniques. However, it should be understood that many variations and modifications may be made while remaining within the spirit and scope of the invention.

What is claimed is:

1. A co-extruded multi-component snack food item, comprising:
an outer jacket comprising about 60% to about 80% by weight of the food item, the outer jacket comprising at least about 40% to about 92% by weight of a starch-containing material; and
a center filling comprising about 30% to about 50% by weight of the food item encased within the outer jacket, the center filling comprising:
(i) about 40% to about 95% by weight of a fat composition, about 5% to about 60% by weight of a flavoring component, and about 0% to about 2% by weight of an emulsifier; or
(ii) about 10% to about 95% by weight of a fat composition, about 10% to about 50% by weight of a foam composition, about 5% to about 60% by weight of a flavoring component, and about 0% to about 2% by weight of an emulsifier

2. The co-extruded multi-component snack food of claim 1, wherein the foam composition comprises marshmallow crème or marshmallow fluff.

3. The co-extruded multi-component snack food of claim 1, wherein the foam composition comprises low D.E. corn syrup.

4. The co-extruded multi-component snack food of claim 1, wherein the foam composition comprises about 45% to about 65% low D.E. corn syrup by weight, about 15% to about 30% sugar by weight, about 10% to about 20% egg white by weight, about 2% or less cream of tartar by weight; about 2% or less xanthan gum by weight; and about 2% or less artificial flavor by weight.

5. The co-extruded multi-component snack food of claim 3, wherein the corn syrup comprises about 5 D.E. to about 25 D.E.

6. The co-extruded multi-component snack food of claim 1, wherein the foam composition comprises a sweetness reducing agent.

7. The co-extruded multi-component snack food of claim 1, wherein less than about 5% by weight of the center filling migrates into the outer jacket.

8. The co-extruded multi-component snack food of claim 1, wherein the fat composition comprises about 5% or less trans fat by weight.

9. The co-extruded multi-component snack food of claim 1, wherein the fat composition comprises about 98% to about 99.5% fat component by weight and about 0% to about 2% emulsifier by weight.

10. The co-extruded multi-component snack food of claim 1, wherein the fat composition comprises a partially hydrogenated fat having a solid fat index of:
a) about 47 to about 55 at about 10° C., about 20 to about 25 at about 21.1° C., about 11 to about 15 at about 26.7° C., about 5.5 to about 7.5 at about 33.3° C., and about 1 to about 3.5 at about 40° C.; or
b) less than about 23 at about 10° C., less than about 19 at about 21.1° C., less than about 15.5 at about 26.7° C., less than about 14 at about 33.3° C., and less than about 11 at about 40° C.

11. The co-extruded multi-component snack food of claim 1, wherein the fat composition comprises a solid fat and a liquid fat, the liquid fat being entrapped or fixed within the crystalline structure of the solid fat thereby inhibiting wicking of the liquid fat into the outer jacket component.

12. The co-extruded multi-component snack food of claim 1, wherein the snack food comprises a size of about 0.5 cm to about 10 cm.

13. The co-extruded multi-component snack food of claim 1, wherein the outer jacket comprises one or more texturizing agents.

14. The co-extruded multi-component snack food of claim 13, wherein the texturizing agent comprises one or more of vegetable power, corn meal, corn grist, corn flaking grits, wheat fibers, baking powder, seed meal, double action baking powder, grain bran, fiber, gums, or hydrocolloids.

15. The co-extruded multi-component snack food of claim 1, wherein the outer jacket comprises a crispy and/or crunchy texture.

16. The co-extruded multi-component snack food of claim 1, wherein the outer jacket is cereal, cracker, or biscuit.

17. The co-extruded multi-component snack food of claim 1, wherein the center filling comprises a creamy texture.

18. The co-extruded multi-component snack food of claim 1, wherein the center filling comprises less than 10% moisture by weight.

19. The co-extruded multi-component snack food of claim 1, wherein the center filling comprises water activity (a_{w}) of less than 0.7.

20. A method of making a co-extruded multi-component snack food according to claim 1, comprising:
co-extruding the outer jacket with the center filling to form a co-extruded multi-component snack food, wherein the center filling is encased within the outer jacket; and
baking the co-extruded multi-component snack food to reduce moisture content of the outer jacket.
